(19) United States
(12) Patent Application Publication
(10) Pub. No.: US 2017/0222280 A1
(43) Pub. Date: Aug. 3, 2017

(54) LAMINATED BATTERY

(71) Applicant: Panasonic Intellectual Property Management Co., Ltd., Osaka (JP)

(72) Inventors: YUYA ASANO, Osaka (JP); TOMOHIRO UEDA, Osaka (JP); YOKO SANO, Osaka (JP)

(73) Assignee: Panasonic Intellectual Property Management Co., Ltd., Osaka (JP)

(21) Appl. No.: 15/326,074

(22) PCT Filed: Aug. 5, 2015
(86) PCT No.: PCT/JP2015/003931

§ 371 Date: Jan. 13, 2017

(30) Foreign Application Priority Data
Sep. 29, 2014 (JP) 2014-198737

(51) Int. Cl. H01M 10/42; H01M 4/525; H01M 4/62; H01M 2/16; H01M 4/66; H01M 10/0568; H01M 10/0569; H01M 10/0525; H01M 4/587

(52) U.S. Cl. CPC H01M 10/4235; H01M 10/0525; H01M 4/525; H01M 4/625; H01M 4/623; H01M 4/587; H01M 4/661; H01M 10/0568; H01M 10/0569; H01M 2/168; H01M 2200/00; H01M 2300/004

(57) ABSTRACT

A laminated battery includes a stacked electrode group including a positive electrode, a negative electrode, a dummy electrode, a first separator interposed between the positive and negative electrodes, and a second separator interposed between the positive and/or negative electrode and the dummy electrode; and an electrolyte. At least one positive electrode and/or at least one negative electrode includes a single-sided electrode including a current collector and an electrode active material layer formed on a first surface of the current collector. A second surface of the current collector is exposed. The dummy electrode is a metal foil facing the second surface of the current collector of the single-sided electrode and having a polarity opposite to that of the single-sided electrode. Adhesive strengths F₁ and F₂ on both sides of the first separator and adhesive strengths F₃ and F₄ on both sides of the second separator satisfy F₁+F₂>F₃+F₄.

### TECHNICAL FIELD

The present invention relates to an improvement of a configuration of an electrode group of a laminated battery (or a battery using a laminate sheet for a housing).

### BACKGROUND ART

With diversification of applications of batteries, demands for light and thin laminated batteries have been increasing. Since a laminated battery is thin, it is easily broken. Accordingly, it is important to secure safety at the time of breakage. When an internal short circuit occurs due to breakage of a battery, heat is generated and safety is lost.

For the purpose of improving safety at the time of an internal short circuit, PTL 1 has proposed that a dummy electrode which does not have an electrode active material layer is disposed such that it faces the outermost electrode of a stacked electrode group, thereby causing a short circuit to occur in a dummy electrode portion when the battery reaches a predetermined temperature or more.

PTL 2 describes a battery that houses a stacked electrode group sandwiched between two dummy electrodes in the battery container in a state in which a wall resin is disposed between the dummy electrodes and the battery container. When the temperature inside the battery rises, the wall resin is allowed to melt or contract at a temperature lower than the temperature inside the electrode, thereby causing a short circuit to occur between the dummy electrode and the container.

### CITATION LIST

### Patent Literature

PTL 1: Japanese Patent Application Unexamined Publication No. 2002-270239
PTL 2: Japanese Patent Application Unexamined Publication No. 2012-138287

### SUMMARY OF THE INVENTION

### Technical Problem

When an internal short circuit occurs in a part of the inside of a battery due to breakage (including nail penetration) and the like of the battery, an electric current is concentrated on a short-circuit place and heat generation occurs therein. When heat generation causes a separator in the short-circuit place to melt or contract, a short-circuit region is expanded. Even when a dummy electrode is used as in PTLs 1 and 2, when such an internal short circuit occurs between active material layers (that is, a region in which the positive electrode active material layer and the negative electrode active material layer face each other), the heat generation becomes remarkable, and thus, the safety of the battery is damaged.

At the time of breakage of the battery, an electrode group is deformed largely. Consequently, a separator is displaced in the electrode group, which also causes an internal short circuit. Also in a nail penetration test of the battery, at the time when penetration of a nail is carried out, the separator is pulled, so that displacement occurs. Even when a dummy electrode is used as in PTLs 1 and 2, when such a displacement of the separator occurs between the active material layers, the short-circuit region is expanded remarkably between the active material layers in which heat generation easily occurs. Therefore, it is difficult to sufficiently suppress expansion of a short-circuit region between the active material layers only by providing the dummy electrode.

It is an object of the present invention to improve safety of the battery by suppressing expansion of the internal short circuit region between the active material layers.

### Solution to Problem

One aspect of the present invention includes a stacked electrode group including at least one positive electrode, at least one negative electrode, at least one dummy electrode, a first separator interposed between the positive electrode and the negative electrode, and a second separator interposed between the positive electrode and/or the negative electrode and the dummy electrode; and an electrolyte.

The positive electrode and the negative electrode each includes a current collector and an electrode active material layer formed on a surface of the current collector. At least one positive electrode and/or at least one negative electrode includes a single-sided electrode including the current collector and the electrode active material layer formed on a first surface of the current collector, and in which a second surface of the current collector is exposed.

The dummy electrode is a metal foil facing the second surface of the current collector of the single-sided electrode, and having an opposite polarity to a polarity of the single-sided electrode.

In a laminated battery, an adhesive strength F₁ between the first separator and the electrode active material layer on a first surface side of the first separator, an adhesive strength F₂ between the first separator and the electrode active material layer on the second surface side of the first separator, an adhesive strength F₃ between the second separator and the second surface of the current collector of the single-sided electrode, and an adhesive strength F₄ between the second separator and the dummy electrode satisfy: F₁+F₂>F₃+F₄.

### Advantageous Effect of Invention

The present invention can suppress displacement and/or contraction of a first separator between active material layers as compared with displacement and/or contraction of a second separator which is in contact with a dummy electrode. In other words, at the time of breakage of a battery, since displacement and/or contraction preferentially occurs in the second separator, it is possible to reduce a voltage at an early stage. Therefore, expansion of a region of an internal short circuit among the active material layers can be suppressed, and as a result, the safety of the battery can be improved.

### BRIEF DESCRIPTION OF THE DRAWINGS

FIG. 1 is a top view of a laminated battery in accordance with a first exemplary embodiment of the present invention.

FIG. 2 is a sectional view schematically showing a configuration of a stacked electrode group in the laminated battery of FIG. 1.

FIG. 3 is a sectional view schematically showing a configuration of a stacked electrode group in accordance with a second exemplary embodiment of the present invention.

FIG. 4 is a sectional view schematically showing a configuration of a stacked electrode group in accordance with a third exemplary embodiment of the present invention.

FIG. 5 is a sectional view schematically showing a configuration of a stacked electrode group in accordance with a fourth exemplary embodiment of the present invention.

### MODE FOR CARRYING OUT INVENTION

### DESCRIPTION OF EMBODIMENTS

A laminated battery in accordance with one exemplary embodiment of the present invention includes a stacked electrode group including at least one positive electrode, at least one negative electrode, at least one dummy electrode, a first separator interposed between the positive electrode and the negative electrode, and a second separator interposed between the positive electrode and/or the negative electrode and the dummy electrode; and an electrolyte. The positive electrode and the negative electrode each includes a current collector and an electrode active material layer formed on a surface of the current collector. At least one positive electrode and/or at least one negative electrode includes a single-sided electrode including the current collector and the electrode active material layer formed on a first surface of the current collector. A second surface of current collector is exposed. The dummy electrode is a metal foil facing the second surface of the current collector (that is to say, an exposed surface of the current collector) of the single-sided electrode, and having an opposite polarity to a polarity of the single-sided electrode. Herein, an adhesive strength F₁ between the first separator and the electrode active material layer on a first surface side of the first separator, an adhesive strength F₂ between the first separator and the electrode active material layer on the second surface side of the first separator, an adhesive strength F₃ between the second separator and the second surface (exposed surface) of the current collector of the single-sided electrode, and an adhesive strength F₄ between the second separator and the dummy electrode satisfy: F₁+F₂>F₃+F₄.

When the adhesive strengths F₃+F₄ are made smaller than the adhesive strengths F₁+F₂, contraction or displacement at the time of breakage (including at the time of nail penetration) of the battery occurs more easily in the second separator interposed between the dummy electrode and the exposed surface of the single-sided electrode than in the first separator interposed between the active material layers. Consequently, even when an internal short circuit occurs due to the breakage of a battery, expansion of the short-circuit region in the first separator between the active material layers is suppressed, the short-circuit region in the second separator between the dummy electrode and the exposed surface of the single-sided electrode is easily expanded. Since the current collector of the single-sided electrode is made of a metal foil, the second separator is interposed between the metal foils. As mentioned above, when an internal short circuit occurs due to breakage of a battery, the short-circuit region due to displacement or contraction is expanded in the second separator than in the first separator, a large amount of short-circuit current flows between the metal foils (between the dummy electrode and the exposed surface of the single-sided electrode). Short circuit resistance and an amount of heat generation are small in the short circuit between the metal foils. Thus, it is possible to suppress flowing of a large amount of short-circuit current between high-resistance active material layers, and to suppress heat generation. As a result, it is possible to enhance the safety of the battery.

A ratio (F₃+F₄)/(F₁+F₂) of a total of the adhesive strengths F₃+F₄ to a total of the adhesive strengths Fi +F₂ is, for example, 0.025 or more, preferably 0.05 or more, and more preferably 0.1 or more. (F₃+F₄)/(F₁+F₂) is preferably 0.7 or less or 0.6 or less, more preferably 0.5 or less or 0.4 or less, and may be 0.35 or less. These lower limit values and upper limit values can be arbitrarily combined. (F₃+F₄)/(F₁+F₂) may satisfy, for example, 0.025 (F₃+F₄)/(F₁+F₂)≦0.7, 0.025 (F₃+F₄)/(F₁+F₂)≦0.5, or 0.05≦(F₃+F₄)/(F₁+F₂)≦0.5.

When the adhesive strength ratio (F₃+F₄)/(F₁+F₂) is in the above-mentioned range, the short-circuit region in the second separator part can be expanded more easily, and a larger amount of electric current is allowed to flow between the metal foils more easily while the entire structural strength of the electrode group is held.

The total of the adhesive strengths F₃+F₄ is, for example, 0.1 to 1.0 N/cm², and preferably 0.1 to 0.9 N/cm² or 0.1 to 0.8 N/cm². When the total of the adhesive strengths F₃+F₄ is in this range, the short-circuit region in the second separator part is expanded more easily.

In order to enhance the adhesiveness between the first separator and the electrode active material layer, it is preferable to provide an adhesion layer between the first separator and the electrode active material layer. An adhesion layer can be provided also between the second separator and the exposed surface and/or the dummy electrode, but it is preferable that the adhesion layer is not provided between the second separator and the exposed surface so that the short-circuit region is easily expanded.

From the viewpoint of ease of obtaining an appropriate adhesive strength, it is preferable that the adhesion layer includes fluorocarbon resins such as vinylidene fluoride-based polymers (for example, polyvinylidene fluoride (PVDF), vinylidene fluoride copolymer), and the like.

The first separator preferably includes aromatic polyamide. Since aromatic polyamide has high heat resistance, it is easy to suppress expansion of the short-circuit region in the first separator.

It is preferable that a thickness of the dummy electrode is larger than a thickness of the current collector having the same polarity as that of the dummy electrode. In this case, an internal short circuit is generated more easily in the dummy electrode part, and an electric current flows more easily.

It is preferable that a projected area of the dummy electrode is larger than a projected area of the single-sided electrode. Also this case is advantages from the viewpoint of enhancing the safety because internal short circuit easily occurs in the dummy electrode part.

Hereinafter, the configuration of a battery is described more specifically.

### Stacked Electrode Group

A stacked electrode group includes at least one positive electrode and at least one negative electrode. The number of the positive electrode and the number of the negative electrode are not particularly limited and may be one, respectively. At least one of the positive electrode and the negative electrode may be a plurality of numbers. The total number of the positive and negative electrodes may be, for example, 3 to 15 and preferably 3 to 10.

Each of the positive electrode and the negative electrode includes a current collector and an electrode active material layer formed on the surface of the current collector. Each electrode may be a double-sided electrode having electrode active material layers on both surfaces of the current collector or may be a single-sided electrode having an electrode active material layer on a first surface of the current collector. The single-sided electrode has an exposed surface to which a second surface of the current collector is exposed. The single-sided electrode or the double-sided electrode having a positive electrode active material layer on one or both surfaces of the positive electrode current collector is also referred to as a single-sided positive electrode or a double-sided positive electrode, respectively. The single-sided electrode or the double-sided electrode having a negative electrode active material layer on one or both surfaces of the negative electrode current collector is also referred to as a single-sided negative electrode or a double-sided negative electrode, respectively.

In the electrode group, at least one positive electrode and/or at least one negative electrode includes a single-sided electrode. From the viewpoint of effectively using the electrode active material and facilitating the expansion of the short-circuit region in the second separator part, regardless of whether the double-sided electrode is used or the single-sided electrode is used, it is desirable that electrode active material layers be allowed to face each other, and the exposed surface of the single-sided electrode be allowed to face the dummy electrode.

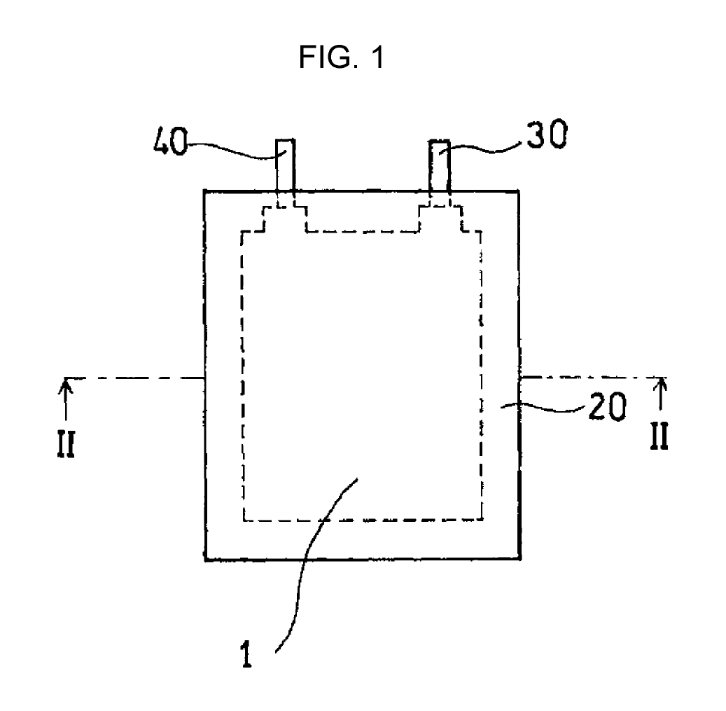

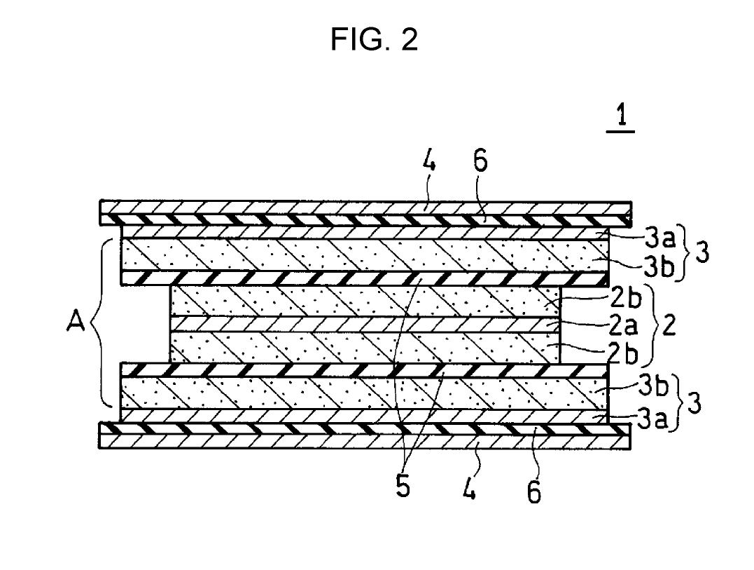

FIG. 1 is a top view of a laminated battery in accordance with one exemplary embodiment (a first exemplary embodiment) of the present invention. FIG. 2 is a schematic sectional view taken on line II-II of a stacked electrode group included in the laminated battery of FIG. 1. The laminated battery includes housing 20, and stacked electrode group 1 and an electrolyte (not shown) housed in housing 20. Stacked electrode group 1 includes a positive electrode and a negative electrode. Positive electrode lead terminal 30 is connected to the positive electrode. Negative electrode lead terminal 40 is connected to the negative electrode.

Stacked electrode group 1 includes one positive electrode 2, two negative electrodes 3, two dummy electrodes 4, first separator 5, and second separator 6. Positive electrode 2 is a double-sided positive electrode including positive electrode current collector 2a, and positive electrode active material layers 2b formed on both surfaces of positive electrode current collector 2a. Negative electrode 3 is a single-sided negative electrode including negative electrode current collector 3a, and negative electrode active material layer 3b formed on a first surface of negative electrode current collector 3a. Negative electrode active material layer 3b is not formed on a second surface of negative electrode current collector 3a. On the second surface, negative electrode current collector 3a is exposed. Two single-sided negative electrodes 3 are disposed to sandwich double-sided positive electrode 2 in such a manner that positive electrode active material layer 2b and negative electrode active material layer 3b face each other.

First separator 5 is disposed between positive electrode active material layer 2b and negative electrode active material layer 3b, and electrically insulates positive electrode 2 and negative electrode 3 from each other.

Dummy electrode 4 is disposed on the outermost layer so as to face an exposed surface of negative electrode current collector 3a of single-sided negative electrode 3. Dummy electrode 4 is, for example, an aluminum foil and has a positive polarity. Second separator 6 is disposed between dummy electrode 4 and an exposed surface of single-sided negative electrode 3, and electrically insulates dummy electrode 4 and negative electrode 3 from each other.

An adhesion layer (not shown) including vinylidene fluoride-based polymer is formed between first separator 5 and negative electrode active material layer 3b and/or positive electrode active material layer 2b. An adhesion layer is not formed between second separator 6 and the exposed surface of single-sided electrode 3 and/or dummy electrode 4. Thus, the total adhesive strengths F₃+F₄ can be made smaller than the total adhesive strengths F₁+F₂, where F₁ denotes an adhesive strength between first separator 5 and positive electrode active material layer 2b, F₂ denotes an adhesive strength between first separator 5 and negative electrode active material layer 3b, F₃ denotes an adhesive strength between second separator 6 and the exposed surface and F₄ denotes an adhesive strength between second separator 6 and dummy electrode 4. Thus, at the time of short circuit, a short-circuit region in second separator 6 can be expanded while displacement and/or contraction of first separator 5 is suppressed. By allowing a large short-circuit current to flow between the exposed surface of single-sided electrode 3 having lower resister and dummy electrode 4 than between positive electrode active material layer 2b and negative electrode active material layer 3b, a voltage of a battery can be rapidly reduced in a safe state. Therefore, a large short-circuit current does not flow between the active material layers, and heat generation can be suppressed and safety of the battery can be enhanced.

Note here that stacked electrode group 1 includes one unit A including double-sided positive electrode 2 and two negative electrode active material layers 3b sandwiching double-sided positive electrode 2, and two first separators 5 each interposed between positive electrode 2 and negative electrode active material layer 3b. FIG. 2 shows an example in which the electrode group includes one unit A, but the electrode group may include a plurality of units A.

Stacked electrode group 1 is not necessarily limited to the example shown in FIG. 2 and may have a stacked structure in which a single-sided positive electrode and a single-sided negative electrode are laminated with the first separator interposed therebetween. In this case, a dummy electrode having a negative polarity may be disposed to face a current collector exposed surface of the single-sided positive electrode with a second separator interposed therebetween, and a dummy electrode having a positive polarity may be disposed to face a current collector exposed surface of the single-sided negative electrode with the second separator interposed therebetween.

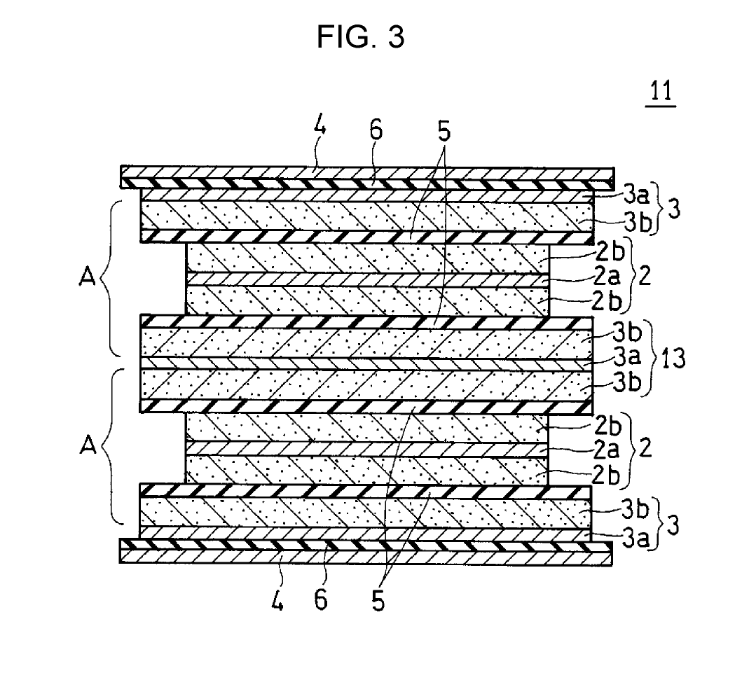

FIG. 3 is a schematic sectional view of a stacked electrode group included in a laminated battery in accordance with a second exemplary embodiment.

Stacked electrode group 11 has a structure in which two positive electrodes 2 and three negative electrodes 3 and 13 are alternately stacked with first separator 5 interposed between positive electrodes 2 and each of negative electrodes 3 and 13. Negative electrode 13 disposed between two positive electrodes 2 is a double-sided negative electrode including negative electrode current collector 3a and negative electrode active material layers 3b formed on both surfaces of negative electrode current collector 3a. Positive electrode 2 is a double-sided positive electrode including positive electrode current collector 2a and positive electrode active material layers 2b formed on both surfaces of positive electrode current collector 2a. Single-sided negative electrodes 3 are laminated on the outer sides of two positive electrodes 2 with first separator 5 interposed between positive electrodes 2 and negative electrodes 3, respectively. Single-sided negative electrode 3 includes, same as in the example shown in FIG. 2, negative electrode current collector 3a and negative electrode active material layer 3b formed on a first surface of negative electrode current collector 3a, and negative electrode current collector 3a is exposed to a second surface of negative electrode current collector 3a.

Stacked electrode group 11 is an example including two units A. Stacked electrode group 11 includes, the same as in the example shown in FIG. 2, dummy electrodes 4 disposed on both the outermost layers via second separators 6, respectively. Each of dummy electrodes 4 on each of the outermost layers faces negative electrode current collector 3a of single-sided negative electrode 3 via second separator 6, respectively.

Also in stacked electrode group 11, similar to the case of FIG. 2, an adhesion layer (not shown) including vinylidene fluoride-based polymer is formed between first separator 5 and positive electrode active material layer 2b and/or negative electrode active material layer 3b. Therefore, at the time of short circuit, displacement and/or contraction of first separator 5 are suppressed, expansion of the short-circuit region between first separator 5 and positive electrode active material layer 2b and/or negative electrode active material layer 3b is suppressed.

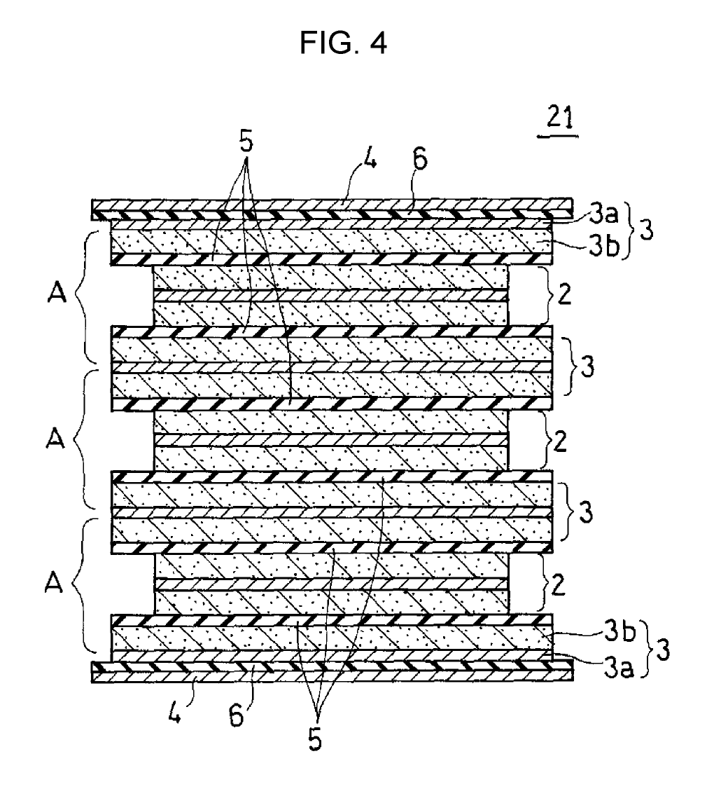

FIG. 4 is a schematic sectional view of a stacked electrode group included in a laminated battery in accordance with a third exemplary embodiment.

Stacked electrode group 21 includes three units A of FIG. 2. Similar to the case of FIG. 3, dummy electrodes 4 are disposed on both the outermost layers via second separators 6, respectively.

The stacked electrode group is not necessarily limited to the example shown in FIGS. 3 and 4, and may include four or more (for example, four to seven, or four to five) units A. Furthermore, in electrode groups shown in FIGS. 2 to 4 or electrode groups including four or more units A, a structure in which a positive electrode and a negative electrode are interchanged from each other may be employed. At this time, the dummy electrode may have a negative polarity and face the exposed surface of the single-sided positive electrode.

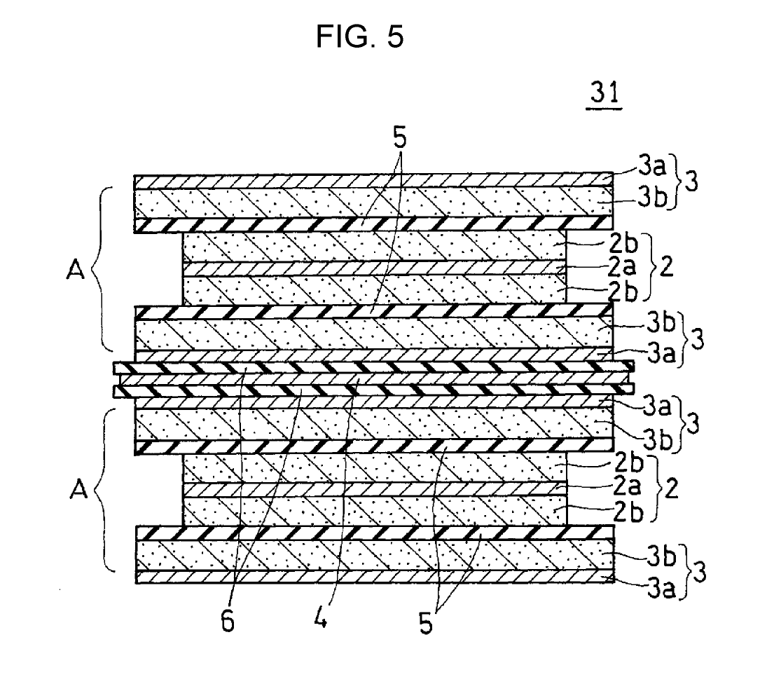

FIGS. 2 to 4 show an example in which a dummy electrode is formed on the outermost layers of the electrode group. A dummy electrode is not necessarily limited to be disposed on the outermost layer, and can be disposed at the more inside of the electrode group. One example in this case is shown in FIG. 5.

FIG. 5 is a schematic sectional view of a stacked electrode group included in a laminated battery in accordance with a fourth exemplary embodiment of the present invention.

Stacked electrode group 31 includes two units A. Between the two units A, dummy electrode 4, which is sandwiched between two second separators 6, is disposed. When dummy electrode 4 is provided more inside, even when the outer film of a battery is pulled into the electrode group due to the drive of nail in the nail penetration test, a short circuit can be allowed to occur in the dummy electrode portion more reliably.

The dummy electrode may be disposed in all parts between adjacent units A, and may be in a part of the adjacent units A.

Note here that the same reference numerals as in FIG. 2 are given to the same configurations shown in FIGS. 3 to 5.

FIGS. 2 to 4 show examples in which the dummy electrodes on the outermost layers have the same polarity, but the dummy electrodes do not necessarily have the same polarity. When the electrode group includes a plurality of dummy electrodes, a part of the dummy electrodes may have a positive polarity and the rest of the dummy electrodes may have a negative polarity.

For constituents of the battery, well-known constituents can be used depending upon the types of each battery. The exemplary embodiment of the present invention is suitable for laminated nonaqueous electrolyte secondary batteries such as, in particular, laminated lithium ion secondary battery, because it is possible to suppress heat generation due to the internal short circuit.

Hereinafter, constituents of the battery are described in more detail with a laminated lithium ion secondary battery given as an example.

### Stacked Electrode Group

An electrode group has a structure in which a positive electrode and a negative electrode are laminated with a first separator interposed therebetween. Then, a dummy electrode is disposed to the outermost layer or inside of the laminated structure with a second separator interposed therebetween.

A thickness of the stacked electrode group can be appropriately selected, but it is preferably 2 mm or less, and more preferably about 0.3 to 1.5 mm or about 0.5 to 1.5 mm

### Positive Electrode

A positive electrode included in an electrode group includes a positive electrode current collector and a positive electrode active material layer formed on a surface of the positive electrode current collector. Individual positive electrode may be a double-sided positive electrode having a positive electrode active material layer on both surfaces of the positive electrode current collector and a single-sided positive electrode having a positive electrode active material layer formed on one surface of the positive electrode current collector.

The positive electrode current collector may be a nonporous conductive substrate (a metal foil, a metal sheet, and the like) or may be a porous conductive substrate having a plurality of through holes (a punching sheet, expanded metal, and the like). When the dummy electrode is allowed to face the exposed surface of the single-sided positive electrode, in order to cause a short circuit more reliably in the dummy electrode portion, it is preferable that a metal foil or a metal sheet is used.

Examples of metal material used for the positive electrode current collector include a stainless steel, aluminum, and an aluminum alloy.

A thickness of the positive electrode current collector can be appropriately selected from the range, for example, 5 to 50 μm, or 10 to 30 μm.

When the stacked electrode group includes a single-sided positive electrode and a double-sided positive electrode, the thickness of the positive electrode current collector of the single-sided positive electrode may be made larger than the thickness of the positive electrode current collector of the double-sided positive electrode. This makes it easy to allow a short-circuit current to flow between the single-sided positive electrode and the dummy electrode.

The positive electrode active material layer contains a positive electrode active material as an essential component, and may further contain, if necessary, a binder, a conductive agent, and/or a thickener.

Examples of the positive electrode active material include a transition metal oxide used in the field of non-aqueous electrolyte secondary batteries.

Specific examples of the transition metal oxide include V₂O₅, V₆O₁₃, WO₃, Nb₂O₅, MnO₂, and the like, and further include composite oxide including lithium and transition metal elements (for example, manganese, cobalt, nickel and/or titanium). Examples of the composite oxide including lithium and a transition metal element include LiMnO₂, LiMn₂O₄, Li₄Mn₅O₁₂, Li₂Mn₄O₉, LiCoO₂, LiNiO₂, Li_{4/3}Ti_{5/3}O₄, and the like. Among them, composite oxide containing lithium and manganese is preferable. The positive electrode active materials may be used singly or in combination of two or more thereof.

Examples of the binder include polyolefin such as polyethylene and polypropylene; fluorocarbon resins such as polytetrafluoroethylene (PTFE), PVDF, vinylidene fluoride copolymer (a vinylidene fluoride- hexafluoropropylene copolymer, and the like), tetrafluoroethylene-hexafluoropropylene copolymer, and the modified products thereof; rubber polymer such as styrene-butadiene rubber (SBR) and modified acrylonitrile rubber; acrylic polymer or the salts thereof.

The ratio of the binder is, for example, 0.1 to 20 parts by mass, and preferably 1 to 10 parts by mass relative to 100 parts by mass of the positive electrode active material.

Examples of the conductive agent include carbon black; conductive fiber such as carbon fiber and metal fiber; carbon fluoride; and natural or artificial graphite. The conductive agent may be used singly or in combination of two or more thereof.

The ratio of the conductive material is, for example, 0 to 15 parts by mass, and preferably 1 to 10 parts by mass relative to 100 parts by mass of the positive electrode active material.

Examples of the thickener include cellulose derivatives such as carboxymethyl cellulose (cellulose ether etc.), polyC₂₋₄ alkylene glycol such as polyethylene glycol and ethylene oxide-propylene oxide copolymer; polyvinyl alcohol; and solubilized modified rubber. The thickener may be used singly or in combination of two or more thereof.

The ratio of the thickener is not particularly limited and is, for example, 0 to 10 parts by mass, preferably 0.01 to 5 parts by mass relative to 100 parts by mass of the positive electrode active material.

The positive electrode can be formed by preparing a positive electrode mixture slurry including the positive electrode active material and applying the positive electrode mixture slurry to a surface of the positive electrode current collector. The positive electrode mixture slurry usually includes a dispersing medium, and as necessary, a binder, a conductive agent, and/or a thickener.

Examples of the dispersing medium include, although not particularly limited, water, alcohol such as ethanol, ether such as tetrahydrofuran, amide such as dimethylformamide, N-methyl-2-pyrrolidone (NMP), and mixed solvents thereof.

A coating film of the positive electrode mixture slurry formed on the surface of the positive electrode current collector is usually dried and compressed in the thickness direction.

The thickness of the positive electrode active material layer (or the positive electrode mixture layer) is, for example, 30 to 100 μm and preferably 50 to 70 μm.

### Negative Electrode

A negative electrode includes a negative electrode current collector and a negative electrode active material layer formed on a surface of the negative electrode current collector. Examples of the negative electrode current collector include nonporous or porous conductive substrate as mentioned as examples of the positive electrode current collector.

Examples of metal material forming the negative electrode current collector include stainless steel, copper, copper alloy, or the like. Among them, copper, or a copper alloy, or the like, is preferable. When a dummy electrode is allowed to face the exposed surface of the single-sided negative electrode, in order to cause a short circuit more reliably in the dummy electrode portion, it is preferable to use a metal foil and a metal sheet as the negative electrode current collector.

The thickness of the negative electrode current collector can be selected from, for example, a range of 5 to 50 μm or 5 to 30 μm.

When the stacked electrode group includes a single-sided negative electrode and a double-sided negative electrode, the thickness of the negative electrode current collector of the single-sided negative electrode may be made larger than the thickness of the negative electrode current collector of the double-sided negative electrode. This makes it easy to allow a short-circuit current to flow between the single-sided negative electrode and the dummy electrode.

The negative electrode active material layer may be a deposited film by a gas phase method or may be a negative electrode mixture layer including a negative electrode active material as an essential component, a binder, a conductive material and/or a thickener as an optional component.

The negative electrode can be prepared according to the preparation method for the positive electrode.

The deposited film can be formed by depositing the negative electrode active material on a surface of the negative electrode current collector by gas phase methods such as a vacuum deposition method, a sputtering method, and an ion plating method. In this case, as the negative electrode active material, for example, silicon, a silicon compound (for example, oxide), a lithium alloy, and the like, can be used.

The negative electrode mixture layer can be formed using a negative electrode mixture slurry according to the case of the positive electrode.

Examples of the negative electrode active material include carbon material; silicon and a silicon compound; and lithium alloy including at least one selected from tin, aluminum, zinc, and magnesium.

Examples of the carbon material include graphite (natural graphite, artificial graphite, graphitized mesophase carbon, and the like), coke, partially graphitized carbon, graphitized carbon fiber, and amorphous carbon (soft carbon, hard carbon, etc.).

The negative electrode active material may be covered with a water-soluble polymer if necessary.

As the binder, the dispersing medium, the conductive material, and the thickener, those mentioned as examples of the positive electrode slurry can be appropriately selected.

The ratio of the binder can be selected from a range of, for example, 0.1 to 10 parts by mass relative to 100 parts by mass of the negative electrode active material.

The ratio of the conductive material is, for example, 0 to 5 parts by mass, or 0.01 to 3 parts by mass relative to 100 parts by mass of the negative electrode active material. The ratio of the thickener is not particularly limited and is, for example, 0 to 10 parts by mass, or 0.01 to 5 parts by mass relative to 100 parts by mass of the negative electrode active material.

The thickness of the negative electrode active material layer (or a negative electrode mixture layer) is, for example, 30 to 110 μm, and preferably 50 to 90 μm.

### First Separator

Examples of a first separator include a microporous film and a non-woven or woven fabric including resin.

Examples of the resin forming the microporous film include polyolefin such as polyethylene, polypropylene, and an ethylene-propylene copolymer; aromatic polyamide (for example, wholly aromatic polyimide such as aramid); polyphenylene sulfide; polyimide resin such as polyimide and polyamide-imide; polyether ether ketone; fluorocarbon resin, and the like.

These resins may be used singly or in combination of two or more thereof. The microporous film may include a filler (for example, fiber and/or particles) formed of inorganic material in addition to resin.

The woven fabric or non-woven fabric can be formed of resin and/or an inorganic material (for example, glass fiber), and the like. As the resin, resins mentioned as examples of the microporous film can be appropriately selected.

From the viewpoint of suppressing expansion of the short-circuit region in the first separator, it is preferable to use a first separator including thermal resistant material. Examples of the thermal resistant material include a heat resistant resin, an inorganic material (inorganic filler such as a glass fiber) and the like. The thermal resistant materials may be used singly or in combination of two or more thereof. Examples of the heat resistant resins include aromatic polyamide, polyphenylene sulfide, polyimide resin, and/or polyether ether ketone, and the like, among the above-mentioned resins.

The first separator may be a single-layered separator, or may be a stacked separator. For example, a stacked film including a layer including polyolefin and a layer including heat resistant resin (for example, a film in which a layer including polyolefin and a layer including heat resistant resin are stacked, a stacked film in which a layer including polyolefin is sandwiched between two layers including heat resistant resin, and the like) may be used as the first separator.

Adhesiveness between the first separator and the electrode active material layer may be enhanced by providing an adhesion layer on a surface of the first separator. Thus, even when the first separator includes polyolefin and the like having relatively low melting point, the expansion of the short-circuit region in the first separator part can be suppressed.

Furthermore, when the adhesion layer is not formed, for example, use of a first separator including a material having adhesiveness (for example, fluorocarbon resin, etc.) can also secure the adhesiveness.

The thickness of the first separator can be appropriately selected from, for example, 5 to 250 μm, and it may be 5 to 100 μm or 10 to 50 μm.

### Adhesion Layer

It is preferable that an adhesion layer includes adhesive resin. Examples of the adhesive resin include fluorocarbon resin; rubber polymer such as styrene-butadiene rubber and modified acrylonitrile rubber; acrylic polymers or the salts thereof. Preferable examples of the fluorocarbon resin include PVDF, vinylidene fluoride-based polymer such as a vinylidene fluoride-ethylene copolymer, a vinylidene fluoride- hexafluoropropylene copolymer (homopolymer or copolymer of vinylidene fluoride) is preferable. These adhesive resin may be used singly or in combination of two or more thereof. From the viewpoint of ease of obtaining appropriate adhesive strength, it is preferable that an adhesive material layer includes fluorocarbon resin such as a vinylidene fluoride-based polymer.

The adhesion layer can be formed by applying an adhesive resin on the surface of the first separator. Application amount of the adhesive resin (fluorocarbon resin, etc.) is, for example, 1 to 30 g/m², and preferably 1 to 20 g/m² for one surface of the first separator.

The adhesion layer may be formed on one surface or both surfaces of the first separator.

The adhesion layer may include well-known additives, in addition to the adhesive resin.

### Dummy Electrode

For a dummy electrode, a metal foil is used.

The dummy electrode has an opposite polarity to that of a confronted electrode.

When the dummy electrode has a positive polarity, as a metal material forming the dummy electrode, materials mentioned as examples of the positive electrode current collector are used.

When the dummy electrode has a negative polarity, as a metal material forming the dummy electrode, materials mentioned as examples of the negative electrode current collector are used.

A thickness T_{d} of the dummy electrode is, for example, 5 to 50 μm, and preferably 5 to 25 μm or 10 to 25 μm.

From the viewpoint of ease of causing an internal short circuit in the dummy electrode part, the thickness Td of the dummy electrode may be the same as or larger than the thickness T of a current collector (a positive electrode current collector or a negative electrode current collector) having the same polarity as that of the dummy electrode. The thickness ratio T_{d}/T is, for example, 1 to 3 (for example, 1<T_{d}/T≦3), and may be 1 to 2 (for example, 1<T_{d}/T≦2).

The dummy electrode faces an exposed surface of a current collector of the single-sided electrode. In a nail penetration test, penetration by a nail is carried out from the outer side to the inner side of the battery.

Accordingly, from the viewpoint of reliably causing an internal short circuit in the dummy electrode part, it is preferable that a projected area of the dummy electrode is made larger than the projected area of the single-sided electrode. In particular, it is preferable that the projected area of the dummy electrode is made larger than the projected area of the active material layer formed in the facing single-sided electrode by more than one time and 1.3 times or less (for example, 1.01 times to 1.3 times).

Note here that the projected area is referred to as an area of the shadow generated when the dummy electrode or the single-sided electrode is projected in the thickness direction. The dummy electrode and the single-sided electrode may have a lead tab for connecting a lead terminal. The projected area may include or may not include the area of the lead tab. Furthermore, the projected area of the main part of the single-sided electrode (active material layer formation region) may be a projected area of the single-sided electrode.

### Second Separator

Between the dummy electrode and the single-sided electrode, a second separator is disposed.

The second separator may be a microporous film including resin, or may be woven or non-woven fabric including resin. Furthermore, the second separator may be a general non-porous resin film. Resin included in the second separator can be appropriately selected from the resin mentioned as examples of the materials for the first separator.

The second separator may be a single-layered separator or multi-layered separator. The second separator may be the same as the first separator. From the viewpoint of ease of expansion of the short-circuit area in the second separator part, it is preferable that the resin included in the second separator is resin (for example, polyolefin) other than the heat resistant resin rather than heat resistant resin among the resin mentioned as examples.

### Electrolyte

An electrolyte is not particularly limited. Examples of the electrolyte include a liquid electrolyte (an electrolytic solution) obtained by dissolving an electrolyte salt in a solvent, a gel polymer electrolyte obtained by impregnating a polymer matrix with liquid electrolyte, a dry polymer electrolyte in which polymer matrix is allowed to contain an electrolyte salt, an inorganic solid electrolyte, and the like.

Examples of the solvent include a non-aqueous solvent, for example, cyclic carbonic acid esters such as propylene carbonate (PC), ethylene carbonate (EC), and butylene carbonate; chain carbonic acid esters such as diethyl carbonate (DEC), ethyl methyl carbonate, and dimethyl carbonate; cyclic carboxylic acid esters such as y-butyrolactone and y-valerolactone; chain ether such as dimethoxyethane, and the like.

Examples of the electrolytic salt include LiPF₆, LiClO₄, LiBF₄, LiCF₃SO₃, LiCF₃CO₂, and imide salts.

The materials to be used for the polymer matrix (matrix polymers) are not particularly limited. Examples thereof include fluorocarbon resin such as a vinylidene fluoride-based polymer, acrylic resin, and polyether resin including a polyalkylene oxide unit. Examples of the vinylidene fluoride-based polymer include PVDF, vinylidene fluoride -hexafluoropropylene copolymer, a vinylidene fluoride-trifluoroethylene copolymer, and other vinylidene fluoride-based copolymers, and the like.

The inorganic solid electrolyte is not particularly limited, and an inorganic material having ion conductivity can be used.

A laminated battery can be prepared by housing a stacked electrode group, and an electrolyte in a housing, and sealing thereof by a well-known method.

To the positive electrode and the negative electrode of the electrode group, a first end portion of the lead terminal is connected, respectively. Materials for the lead terminal are not particularly limited and may be metal or nonmetal as long as they are electrochemically and chemically stable, and have conductivity. Among them, a metal foil is preferable. Metal materials for the metal foil can be selected from the materials mentioned as examples of the materials for the current collector of the electrode to be connected.

The dummy electrode is electrically connected to an electrode having the same polarity as that of the dummy electrode by a lead terminal. A material for the lead terminal for connecting the dummy electrode can be selected from the materials mentioned as examples of the materials for the dummy electrode depending on the polarity of the dummy electrode.

A lead terminal to be connected to the negative electrode or the dummy electrode having a negative polarity may be ones including nickel.

The thickness of each lead terminal is not particularly limited, and it may be, for example, 25 to 200 μm.

The electrode group is housed in the housing such that the second ends of the lead terminals are pulled to the outside of the housing, respectively. Then, predetermined sections of the housing are subjected to heat sealing by, for example, a hot plate under reduced pressure, and sealed. At this time, after the housing is heat-sealed by using, for example, a hot plate with one side of the housing left so as to form a bag-type housing. From an opening of the bag-type housing, an electrolyte (a solvent and/or an electrolyte salt) is poured. Thereafter, remaining one side may be sealed under reduced pressure. Thus, a laminated battery is prepared.

### Housing

A housing is not particularly limited, but the housing is preferably formed of film material having low gas-transmittance and high flexibility. Specific examples thereof include a barrier layer, and a laminate film including a resin layer formed on both surfaces or one surface of the barrier layer. From the viewpoint of the strength, gas barrier performance, and flexural rigidity, preferable examples of the barrier layer include metal materials such as aluminum, nickel, stainless steel, titanium, iron, platinum, gold, and silver; and inorganic materials (ceramics materials) such as silicon oxide, magnesium oxide, and aluminum oxide. From the similar viewpoint, it is preferable that the thickness of the barrier layer is, for example, 5 to 50 μm.

The resin layer may be a stacked body of two layers or more. From the viewpoint of ease of thermal welding, electrolyte resistance, and chemical resistance, it is preferable that the material for the resin layer disposed at the inner side of the housing is preferably a polyolefin such as polyethylene (PE) and polypropylene (PP); polyethylene terephthalate, polyamide, polyurethane, a polyethylene-vinyl acetate copolymer, or the like. It is preferable that the thickness of the resin layer at the inner surface side is 10 to 100 μm. From the viewpoint of the strength, shock resistance, and chemical resistance, the resin layer (protective layer) disposed at the outer surface side of the housing is preferably a polyamide (PA) such as 6,6-nylon; polyolefin, and polyesters such as polyethylene terephthalate (PET), polybutylene terephthalate, or the like. It is preferable that the thickness of the resin layer (protective layer) at the outer surface side is 5 to 100 μm.

Specifically, examples of the housing include a laminate film of PE/Al layer/PE; a laminate film of acid-modified PP/PET/Al layer/PET; a laminate film of acid-modified PE/PA/Al layer/PET; a laminate film of ionomer resin/Ni layer/PE/PET; a laminate film of ethylene vinyl acetate/PE/Al layer/PET; and a laminate film of ionomer resin/PET/Al layer/PET. Herein, an inorganic compound layer such as an Al₂O₃ layer, and a SiO₂ layer may be used in place of the Al layer.

### EXAMPLE

Hereinafter, the present invention is specifically described based on Examples and Comparative Examples. However, the present invention is not construed to be limited to the following Examples.

### Example 1

A laminated lithium ion secondary battery including a stacked electrode group including four units A shown in FIG. 2 was produced by the following procedures.

### (1) Production of Positive Electrode

LiCoO₂ (positive electrode active material), acetylene black (conductive agent), and PVDF (binder) were mixed with each other in NMP, so that the mass ratio of LiCoO₂: acetylene black : PVDF was 100:2:2, and then an appropriate amount of NMP was further added to the mixture so as to adjust the viscosity to obtain positive electrode mixture slurry.

The positive electrode mixture slurry was applied to both surfaces of an aluminum foil (positive electrode current collector, thickness: 15 μm). The resultant product was dried at 85° C. for 10 min, and compressed using a rolling press machine so as to form a positive electrode active material layer on both surfaces of the positive electrode current collector. The positive electrode current collector having the positive electrode active material layer on both surfaces thereof was cut into a rectangular main part (longer side: 105 mm and shorter side: 17 mm) provided with the positive electrode active material layer and a shape having a lead tab extending from one of the shorter sides of the main part, followed by drying under reduced pressure at 120° C. for two hours. Thereafter, positive electrode active material layers formed on both surfaces of the lead tab portion were peeled off. Thus, four double-sided positive electrodes each having a positive electrode active material layer on both surfaces thereof were produced. Next, one end of the positive electrode lead terminal made of aluminum (width: 3 mm and thickness: 50 μm) was ultrasonically welded to one surface of the lead tab of one of the positive electrodes.

### (2) Production of Negative Electrode

One hundred parts by mass of graphite (negative electrode active material), 8 parts by mass of a vinylidene fluoride-hexafluoropropylene copolymer (content of a vinylidene fluoride unit: 5 mol %, binder), and an appropriate amount of NMP were mixed with each other to obtain negative electrode mixture slurry.

A copper foil (negative electrode current collector, thickness: 8μm) was cut into a rectangular main part (longer side: 107 mm, and shorter side: 19 mm) and a shape having a lead tab extending from one of the shorter sides of the main part. The negative electrode mixture slurry was applied to the main part at one side of the obtained cut piece, followed by drying at 85° C. for 10 min, and then compressing the resultant product using a rolling press machine. Thus, two single-sided negative electrodes having a negative electrode active material layer on one surface of the main part were produced. Then, one end of the negative electrode lead terminal made of copper (width: 1.5 mm and thickness: 50 μm) was ultrasonically welded to the lead tab on the surface which was not provided with a negative electrode active material layer of one single-sided negative electrode.

Three double-sided negative electrodes were produced in the same manner as mentioned above except that the negative electrode mixture slurry was applied to the main part of the both surfaces of the cut piece. Thereafter, the negative electrode active material layers formed on both surfaces of the lead tab part were peeled off so as to produce a double-sided negative electrode having the negative electrode active material layers on both surfaces thereof.

### (3) Assembly of Stacked Electrode Group

Four double-sided positive electrodes and three double-sided negative electrodes were laminated alternately with polyethylene microporous film (thickness: 9 μm) as the first separator interposed each between the electrodes. An adhesion layer including a vinylidene fluoride-hexafluoropropylene copolymer was provided between the first separator and the negative electrode active material layer, and between the first separator and the positive electrode active material layer, respectively. An application amount of the vinylidene fluoride -hexafluoropropylene copolymer for one surface of the first separator was 10 g/m².

Single-sided negative electrodes were further stacked on the double-sided positive electrodes at both sides, respectively, via a polyethylene microporous film (thickness: 9 μm) as the first separator such that the negative electrode active material layer faces the positive electrode active material layer.

On each of the negative electrode current collectors of the single-sided negative electrodes exposed to the both ends of the obtained stacked body, an aluminum foil (thickness: 15 μm) as the dummy electrode was stacked via polyethylene microporous film (thickness: 9 μm) as the second separator. Thus, a stacked body was formed. Note here that the dummy electrode was also provided with a lead tab similar to that of the positive electrode. All the lead tabs of the positive electrode and the dummy electrode were electrically jointed to each other by ultrasonic welding. Similarly, all the lead tabs of the negative electrodes were joined to each other.

### (4) Assembly of Battery

A film material (PE protective layer/Al layer/PE seal layer) including an aluminum foil as a barrier layer (thickness: 15 μm), a PE film (thickness: 50 μm) as a seal layer on a first surface of the barrier layer, and a PE film (thickness: 50 μm) as a protective layer on a second surface of the barrier layer was prepared. This film material was molded into a bag-type housing having an outer shape of 120 mm in length×29 mm in width. Then, the electrode group was inserted into the housing from the opening thereof such that second end portions of the positive electrode lead terminal and the negative electrode lead terminal were exposed to the outside.

Next, the electrolyte was injected. Then, the housing that houses the electrode group and the electrolyte was placed in an atmosphere whose pressure was adjusted to 660 mmHg. In this atmosphere, the opening was heat sealed. Next, the housing was hot-pressed in the thickness direction of the electrode group from the outside of the housing in the thermal pressing conditions of 25° C. and 1.0 MPa for 30 seconds. Thus, the laminated lithium ion secondary battery having a size of 120 mm in longer side ×29 mm in shorter side ×1.8 mm in thickness was produced.

As the electrolyte, a liquid electrolyte obtained by dissolving 1 mol/L LiPF₆ (electrolyte salt) in a mixed solvent including PC, EC, and DEC in the ratio of PC:EC:DEC=10:40:50 (mass ratio) was used.

### (5) Evaluation

A stacked electrode group and a battery were evaluated.

### (a) Adhesive Strength

In a region in a part of the stacked electrode group produced as mentioned above, the interface between layers was appropriately peeled off. Thus, stacked body L₄ of the dummy electrode and the second separator, stacked body L₃ of the second separator and the single-sided negative electrode, stacked body L₂ of the single-sided negative electrode and the first separator, as well as stacked body L₁ of the first separator and the double-sided positive electrode were separated from each other. Each stacked body was cut into 15 mm-width band. In the band, a region having a length of 50 mm was left in the center part, an electrode was removed in a first end, and a separator was removed in a second end. Thus, a test piece was produced. Note here that the center part of the test piece was a stacked body of the electrode and the separator.

Next, a tensile load in the longitudinal direction was applied to the test piece under environment at 25° C. at a tensile speed of 20 mm/min by using a tensile tester (TENSILON RTC-1150A manufactured by A&D Company, Limited). The tensile load gradually increases, reaches a peak at a certain time point, and thereafter, rapidly decreases. An adhesive strength (N/cm²) was calculated by dividing the load (N) at the peak time by the bonded area (15 mm×50 mm). Adhesive strengths in test pieces using laminated bodies L₁ to L₄ are Fi to F₄, respectively. Then, the total F₁+F₂ of the adhesive strengths on both surfaces of the first separator and the total F₃+F₄ of the adhesive strengths on both surfaces of the second separator were calculated.

### (b) Nail Penetration Test

A battery was charged at a current value of 0.2 C until the voltage reached 4.2 V. Thereafter, a nail (having a diameter of 3 mm) was allowed to penetrate through the battery at a speed of 1 mm/sec in the thickness direction of the stacked electrode group from the outside of the battery. The battery was held in a state in which the nail penetrates through the battery. The surface temperatures of the battery were monitored and the maximum temperature was measured.

### Examples 2 to 4

Batteries were produced in the same manner as in Example 1 except that an application amount of a vinylidene fluoride-hexafluoropropylene copolymer in the adhesion layers on both surfaces of the first separator and hot-pressing temperatures after pouring of liquid electrolyte were appropriately changed, and the adhesion state was changed. The batteries were evaluated according to Example 1.

### Example 5

A battery was produced in the same manner as in Example 1 except that a stacked film including a polyethylene microporous layer (thickness: 9 μm) and aramid microporous layers (each thickness: 3 μm) formed on both surfaces of the polyethylene microporous layer was used as the first separator, and the battery was evaluated.

### Example 6

A battery was produced in the same manner as in Example 1 except that a thickness of the dummy electrode was changed to 20 μm, and the battery was evaluated. Note here that the thickness of the dummy electrode to be used for evaluation of the adhesive strength was also 20 μm.

### Example 7

A battery was produced in the same manner as in Example 1 except that a thickness of a negative electrode current collector of a single-sided negative electrode was changed to 10 μm, and the battery was evaluated.

### Comparative Example 1

A battery was produced in the same manner as in Example 1 except that an adhesion layer was not formed on both surfaces of the first separator, and the battery was evaluated.

### Comparative Example 2

A battery was produced in the same manner as in Example 1 except that an adhesion layer (thickness: 3 μm) including a vinylidene fluoride-hexafluoropropylene copolymer was formed on both surfaces of the second separator, and the battery was evaluated.

### Comparative Example 3

A battery was produced in the same manner as in Comparative Example 2 except that an adhesion layer was not formed on both surfaces of the first separator, and the battery was evaluated.

Results of Examples and Comparative Examples are shown in Table 1. Note here that Examples 1 to 7 are Al to A7, and Comparative Examples 1 to 3 are B1 to B3, respectively.

TABLE 1

| | | | | Battery surface |
|---|---|---|---|---|
| | Adhesive strength [N/cm²] | | | maximum |
| | F₁ + F₂ | F₃ + F₄ | (F₃ + F₄)/(F₁ + F₂) | temperature [° C.] |
| A1 | 3.0 | 0.8 | 0.267 | 70 |
| A2 | 4.8 | 0.8 | 0.167 | 60 |
| A3 | 6.0 | 0.8 | 0.133 | 55 |
| A4 | 1.4 | 0.8 | 0.571 | 90 |
| A5 | 2.4 | 0.8 | 0.333 | 40 |
| A6 | 3.0 | 0.8 | 0.267 | 65 |
| A7 | 3.0 | 0.8 | 0.267 | 65 |
| B1 | 0.8 | 0.8 | 1.000 | 120 |
| B2 | 3.0 | 3.0 | 1.000 | 150 |
| B3 | 0.8 | 3.0 | 3.750 | 150 |

As shown in Table 1, in the batteries of Examples, the surface temperatures are kept low even when the internal short circuit occurs by the nail penetration test. On the contrary, in the batteries of Comparative Examples, the surface temperatures of the batteries are remarkably increased to high temperatures of higher than 100° C. by the nail penetration test.

### INDUSTRIAL APPLICABILITY

One exemplary embodiment of the present invention can suppress heat generation when an internal short circuit occurs, and can enhance the safety of the laminated stacked battery, so that it can be applied to various applications of use, for example, a thin laminated battery which is easily deformed.

### REFERENCE MARKS IN THE DRAWINGS

1, 11, 21, 31 stacked electrode group
2 positive electrode
2a positive electrode current collector
2b positive electrode active material layer
3, 13 negative electrode
3a negative electrode current collector
3b negative electrode active material layer
4 dummy electrode
5 first separator
6 second separator
A unit A
20 housing
30 positive electrode lead terminal
40 negative electrode lead terminal

1. A laminated battery comprising:
a stacked electrode group including
at least one positive electrode,
at least one negative electrode,
at least one dummy electrode,
a first separator interposed between the positive electrode and the negative electrode, and
a second separator interposed between at least one of the positive electrode and the negative electrode and the dummy electrode; and
an electrolyte,
wherein the positive electrode and the negative electrode each includes a current collector and an electrode active material layer formed on a surface of the current collector,
at least one of the at least one positive electrode and the at least one negative electrode includes a single-sided electrode including the current collector and the electrode active material layer formed on a first surface of the current collector, and in which a second surface of the current collector is exposed,
the dummy electrode is a metal foil facing the second surface of the current collector of the single-sided electrode, and having an opposite polarity to a polarity of the single-sided electrode, and
an adhesive strength F1 between the first separator and the electrode active material layer on a first surface side of the first separator, an adhesive strength F2between the first separator and the electrode active material layer on a second surface side of the first separator, an adhesive strength F3 between the second separator and the second surface of the current collector of the single-sided electrode, and an adhesive strength F4 between the second separator and the dummy electrode satisfy: F1+F2>F3+F4.

2. The laminated battery of claim 1, wherein a ratio (F3+F4)/(F1+F2) of a total of the adhesive strengths F3 +F4 to a total of the adhesive strengths F1+F2 satisfies 0.025≦(F3+F4)/(F1+F2)≦0.7.

3. The laminated battery of claim 1, further comprising an adhesion layer between the first separator and the electrode active material layer, wherein the adhesion layer includes a fluorocarbon resin.

4. The laminated battery of claim 3, wherein the fluorocarbon resin is a vinylidene fluoride-based polymer.

5. The laminated battery of claim 1, wherein the first separator includes aromatic polyamide.

6. The laminated battery of claim 1, wherein a thickness of the dummy electrode is larger than a thickness of the current collector having an identical polarity to the polarity of the dummy electrode.

7. The laminated battery of claim 1, wherein a projected area of the dummy electrode is larger than a projected area of the single-sided electrode.
